(19) United States
(12) Patent Application Publication
(10) Pub. No.: US 2009/0008143 A1
(43) Pub. Date: Jan. 8, 2009

(54) Board having buried patterns and manufacturing method thereof

(75) Inventors: Jin-Yong Ahn, Yongin-si (KR); Chang-Sup Ryu, Yongin-si (KR); Byung-Youl Min, Seongnam-si (KR); Myung-Sam Kang, Seo-gu (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/155,838

(22) Filed: Jun. 10, 2008

(30) Foreign Application Priority Data
Jul. 5, 2007 (KR) 10-2007-0067618

(51) Int. Cl. H01K 3/22; H01R 12/04

(52) U.S. Cl. 174/262; 29/848

(57) ABSTRACT

A board having buried patterns is disclosed. The board may include an insulation panel, a first pattern buried in one side of the insulation panel, a second pattern buried in the other side of the insulation panel with a predetermined insulating thickness between the first pattern and the second pattern, and a via which electrically connects the first pattern and the second pattern. The board having buried patterns according to certain embodiments of the invention can have greater rigidity compared to a board having exposed patterns, for the same insulating thickness. Also, a carrier-insulation set having a particular amount of thickness can be utilized to satisfy the thickness requirement in employing an existing roller apparatus intended for thicker boards.

### CROSS-REFERENCE TO RELATED APPLICATIONS

This application claims the benefit of Korean Patent Application No. 10-2007-0067618 filed with the Korean Intellectual Property Office on Jul. 5, 2007 the disclosure of which is incorporated herein by reference in its entirety.

### BACKGROUND

1. Technical Field

The present invention relates to a board having buried patterns.

2. Description of the Related Art

As electronic equipment are being produced with higher performance and in smaller sizes, the numbers of semiconductor chip terminals are dramatically increasing. In order to improve signal transfer speeds, the core board used in FC-BGA (flip chip ball grid array) packages is becoming thinner and thinner. A low thickness for the core board may lower the loop inductance, where a low loop inductance may improve signal transfer speeds. In the related art, a core board may be employed that is formed from a CCL (copper clad laminate).

The thinner core board, however, can be more limited in preventing deformations during the reflowing process, etc., in the procedures for manufacturing a package, caused by differences in the coefficients of thermal expansion. Also, in cases where the manufacturing process for a thin board employs rollers as a means of transport, bending in the thin board can result in the board being rolled up around a roller.

### SUMMARY

An aspect of the invention provides a board, which has patterns buried in both sides of an insulation layer, to provide a high level of rigidity while maintaining a predetermined insulating thickness.

Another aspect of the invention provides a method of manufacturing a board, in which the transporting process is performed for a carrier-insulation set, so that the predetermined amount of thickness required in the transporting process can be provided.

Still another aspect of the invention provides a board having buried patterns that includes an insulation panel, a first pattern buried in one side of the insulation panel, a second pattern buried in the other side of the insulation panel with a predetermined insulating thickness between the first pattern and the second pattern, and a via which electrically connects the first pattern and the second pattern.

The insulating thickness can be of a value greater than or equal to 20 micrometers and lower than or equal to 40 micrometers, while the depths to which the first pattern and the second pattern are buried in the insulation panel can be greater than or equal to 5 micrometers and lower than or equal to 40 micrometers.

In cases where the first pattern and the second pattern are buried in the insulation panel to depths of 10 micrometers or lower, the insulating thickness may be greater than or equal to 10 micrometers.

In cases where the first pattern and the second pattern are buried in the insulation panel to depths greater than 10 micrometers, the insulating thickness may be greater than or equal to 20 micrometers.

Yet another aspect of the invention provides a method of manufacturing a board having buried patterns that includes forming a first pattern over one side of a first carrier and forming a second pattern over one side of a second carrier, forming a carrier-insulation set by pressing the first carrier and the second carrier onto an insulation panel such that the first pattern and the second pattern are buried in the insulation panel, transporting the carrier-insulation set using rollers, and removing the first carrier and the second carrier. Here, a thickness of the carrier-insulation set can be greater than or equal to 400 micrometers and lower than or equal to 800 micrometers.

In certain embodiments of the invention, the board having buried patterns can be given a higher rigidity than that of a board having exposed patterns. As such, the board can be made strong enough to resist deformations during the subsequent package manufacturing procedures, while maintaining a low thickness. A package may thus be manufactured from a core board formed from a conventional CCL (copper clad laminate), etc., without the need for any additional structure.

The transporting process included in the procedures for manufacturing the board having buried patterns may involve the use of rollers. If an existing roller apparatus intended for transporting thick boards is used in transporting thinner boards, there is a risk of the thin board being rolled up into the apparatus and damaged. Therefore, the thickness of the transported board may have to be kept greater than a predetermined value.

According to one embodiment of the invention, the transporting can be performed for a carrier-insulation set, which may include one or more carriers attached to one or more insulation panels, so that damage to the boards may be avoided. In one example, the thickness of the carrier-insulation set can be made greater than or equal to 400 micrometers, making it possible to utilize an existing roller transport apparatus for thicker boards.

Additional aspects and advantages of the present invention will be set forth in part in the description which follows, and in part will be obvious from the description, or may be learned by practice of the invention.

### BRIEF DESCRIPTION OF THE DRAWINGS

FIG. 1A and FIG. 1B are a perspective view and a cross sectional view of a board having buried patterns according to an embodiment of the invention.

FIG. 2A and FIG. 2B are cross sectional views of a board having protruding patterns and a board having buried patterns that share the same insulating thickness.

FIG. 3A, FIG. 3B, FIG. 3C, FIG. 3D, FIG. 3E, FIG. 3F, FIG. 3G, and FIG. 3H are cross sectional views representing a process diagram for a method of manufacturing a board having buried patterns according to another embodiment of the invention.

FIG. 4 is a flowchart for a method of manufacturing a board having buried patterns according to another embodiment of the invention.

### DETAILED DESCRIPTION

The board having buried patterns and method of manufacturing the board, according to certain embodiments of the invention, will be described below in more detail with reference to the accompanying drawings. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

In describing certain embodiments of the invention with reference to the drawings, those components that are the same or are in correspondence are represented by the same reference numeral, and redundant explanations are omitted.

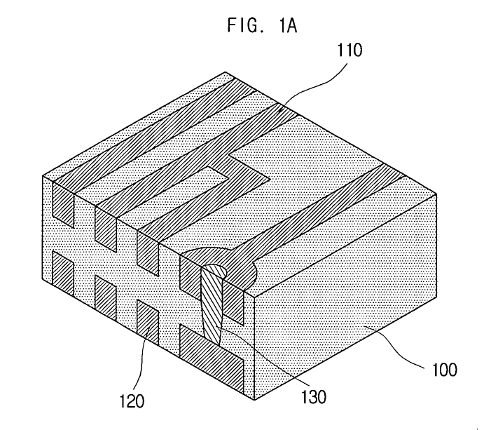

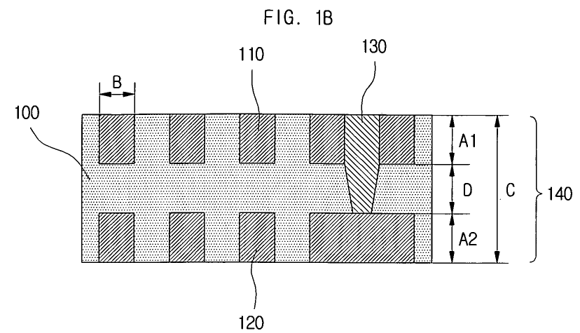

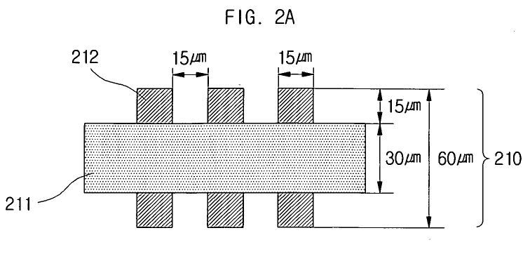

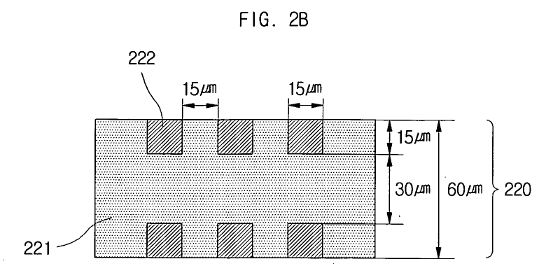

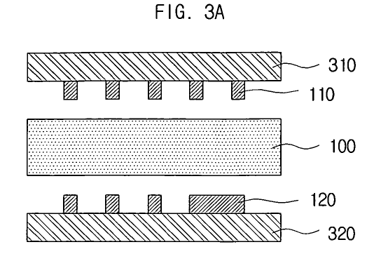

FIG. 1A and FIG. 1B are a perspective view and a cross sectional view of a board having buried patterns according to an embodiment of the invention. In FIGS. 1A and 1B, there are illustrated an insulation panel 100, a first pattern 110, a second pattern 120, a via 130, and a buried-pattern board 140.

The depth to which the first pattern 110 is buried will be denoted by A1, and the width of the first pattern 110 will be denoted by B. The depth to which the second pattern 120 is buried will be denoted by A2, and the width of the second pattern 120 will be denoted by B, the same as the width of the first pattern 110. The insulating thickness by which the first pattern 110 and the second pattern 120 are separated will be denoted by D, and the thickness of the buried-pattern board 140 itself will be denoted by C.

The dimensions described above may vary according to the usage and function of the buried-pattern board 140. Likewise, the wiring intervals in the first pattern 110 and second pattern 120 may also be changed.

In accordance with typical rules-of-thumb in designing a package, the depths A1, A2 to which the first pattern 110 and the second pattern 120 are buried in the insulation panel 100 can be kept greater than or equal to 5 micrometers and lower than or equal to 40 micrometers.

The first and second patterns 110, 120 can be buried entirely in the insulation panel 100. In this case, the buried depth can be kept at 5 micrometers or greater, to ensure reliable electrical connections within the patterns.

Also, in order to keep the required forces below a certain level during the process for burying the first and second patterns 110, 120 in the insulation panel 100, it can be advantageous to keep the buried depths at 40 micrometers or lower.

The width B of the first pattern 110 can be selected, according to typical design rules-of-thumb, within a range of several micrometers. The width of the second pattern 120 may be in a corresponding relationship with the width B of the first pattern 110.

Here, in order to keep the impedance between the first pattern 110 and second pattern 120 at a level corresponding to design rules-of-thumb, the insulating thickness D can also be maintained greater than or equal to 20 micrometers and lower than or equal to 40 micrometers.

By keeping the value of the insulating thickness D greater than or equal to 20 micrometers, the impedance between the first pattern and the second pattern can be made a value that is in accordance with a level required by design rules-of-thumb.

In cases where the insulating thickness is about 40 micrometers, if the buried depths A1, A2 of the first pattern and second pattern are 30 micrometers or greater, the board having buried patterns may become quite thick, with the overall thickness being 100 micrometers or greater.

In cases where the depths to which the first pattern 110 and second pattern 120 are buried in the insulation panel 100 are about 10 micrometers, the insulation thickness may be maintained at 10 micrometers or greater, in order to satisfy the levels of physical rigidity required in the subsequent processes.

In cases where the depths to which the first pattern 110 and second pattern 120 are buried in the insulation panel 100 exceed 10 micrometers, the insulation thickness may be designed to be 20 micrometers or greater, in order to provide greater stability in the process for burying the first and second patterns 110, 120.

A core board based on the related art may generally have a thickness of about 800 micrometers. In comparison, the overall thickness of a buried-pattern board 140 based on this embodiment may be only about 120 micrometers, even when an insulation thickness of 40 micrometers and buried depths of 40 micrometers for the patterns are used.

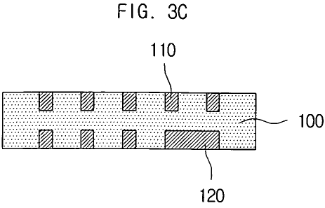

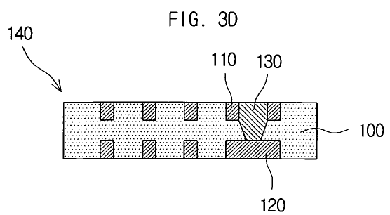

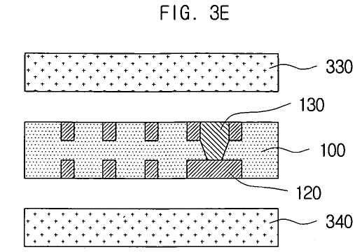

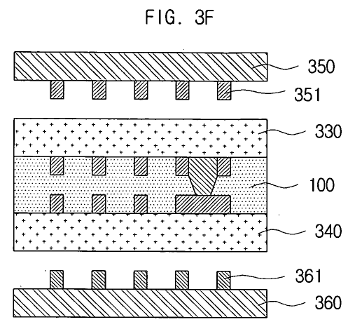

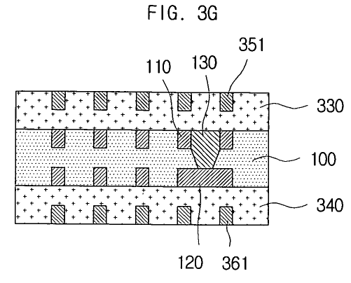

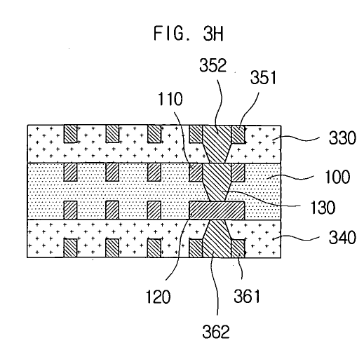

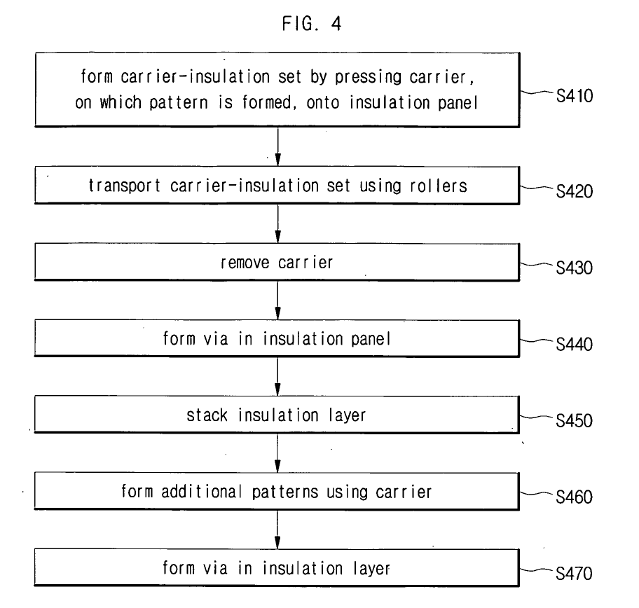

The via 130 may electrically connect the first pattern 110 with the second pattern 120. The via 130 can be made from the same material as that of either the first pattern 110 or the second pattern 120. A method of forming the via will be described later with reference to FIGS. 3A to 3H and FIG. 4.

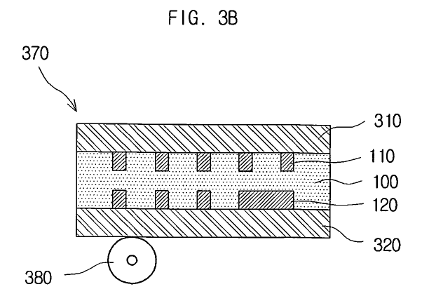

FIG. 2A and FIG. 2B are cross sectional views of a board having protruding patterns and a board having buried patterns that share the same insulating thickness. In FIGS. 2A and 2B, there are illustrated a protruding-pattern board 210 and a buried-pattern board 220.

In FIG. 2A, a protruding-pattern board 210 is illustrated, which may include protruding patterns 212 on both sides of an insulation panel 211. The width of a protruding pattern 212 can be 15 micrometers, and the height to which the pattern 212 protrudes can also be 15 micrometers.

In this case, the thickness of the insulation panel 211, which can be 30 micrometers, may be regarded as the insulating thickness between the patterns 212 formed on either side of the insulation panel 211. The overall thickness of the protruding-pattern board 210 can thus be about 60 micrometers.

In FIG. 2B, a buried-pattern board 220 is illustrated, which includes patterns 222 buried in both sides of an insulation panel 221. The width of a buried pattern 222 can be 15 micrometers, the same as the patterns 212 illustrated in FIG. 2A. The depth to which a pattern 222 is buried in the insulation panel 221 can be 15 micrometers.

Between the two boards 210, 220 illustrated in FIGS. 2A and 2B, the rigidity of the buried-pattern board 220 may generally be greater. Therefore, the buried-pattern board 220 may be more advantageous in terms of providing the desirable rigidity for the process of manufacturing a package while maintaining the same insulation thickness.

FIG. 3A through FIG. 3H are cross sectional views representing a process diagram for a method of manufacturing a board having buried patterns according to another embodiment of the invention, while FIG. 4 is a flowchart for a method of manufacturing a board having buried patterns according to another embodiment of the invention. In FIGS. 3A to 3H, there are illustrated an insulation panel 100, a first pattern 110, a second pattern 120, vias 130, 352, 362, a first carrier 310, a second carrier 320, a first insulation layer 330, a second insulation layer 340, a third carrier 350, a third pattern 351, a fourth carrier 360, a fourth pattern 361, a carrier-insulation set 370, and a roller 380.

An operation of pressing carriers, on which patterns are formed, onto an insulation panel to form a carrier-insulation set (S410) will be described with reference to FIG. 3A and FIG. 3B.

In this particular embodiment, the first carrier 310 can be a metal carrier. A first pattern 110 can be formed by plating a conductive material, such as metal, etc., over one side of the first carrier 310.

The first carrier 310 may also be made from glass or a polymer material, and the method of forming the first pattern 110 may vary in correspondence with the material of the first carrier 310. For example, if the first carrier 310 is made of glass, the forming of the first pattern 110 may include first forming a seed layer and then applying a semi-additive process.

A second carrier 320 and a second pattern 120 may be formed in substantially the same manner as described for the first carrier 310 and first pattern 110.

The carriers 310, 320 that each have the respective pattern 110, 120 formed on one side can be pressed onto the insulation panel 100 to form a carrier-insulation set 370. The first and second patterns 110, 120 can be buried in the insulation panel 100.

An operation of transporting the carrier-insulation set using rollers (S420) will be described with reference to FIG. 3B. The carrier-insulation set 370 can be transported by rollers 380 to the location where a subsequent process will be performed.

In this particular embodiment, the thickness of the carrier-insulation set 370 can be made 400 micrometers or greater, in order to prevent damage during the transporting process and to utilize an existing transport apparatus that is intended for thick boards.

As mentioned above, the thickness of the buried-pattern board 140 may only be about several tens of micrometers. Therefore, the thicknesses of the carriers can be relatively greater, to provide the thickness required in the roller-transporting process.

An operation of removing the carriers (S430) will be described with reference to FIG. 3C. In this particular embodiment, the first and second carriers 310, 320 may be metal carriers. After the transporting process, the first and second carriers 310, 320 can be removed using an etching process.

Since the first and second patterns 110, 120 may be buried in the insulation panel 100, the etching process may not lead to problems of undercutting, etc., which may occur with protruding patterns.

An operation of forming vias will in the insulation panel (S440) will be described with reference to FIG. 3D. The vias may electrically connect the first and second patterns 110, 120 to each other. Via holes may first be formed using laser processing, etc., after which a plating process, etc., may be performed to fill the via holes with a conductive material such as metal.

An operation of stacking on insulation layers (S450) will be described with reference to FIG. 3E. A first and second insulation layer 330, 340 can be formed over each side of the buried-pattern board 140, to cover the first and second patterns 110, 120.

While this particular embodiment is illustrated using an example in which the insulation layers are stacked in the form of insulating film, it is also possible to form the insulation layers by coating a liquid insulating material. The first and second insulation layers 330, 340 can be made from the same material as that of the insulation panel 100.

An operation of forming additional patterns using carriers (S460) will be described with reference to FIGS. 3F and 3G. A third carrier 350, on one side of which a third pattern 351 is formed, and a fourth carrier 360, on one side of which a fourth pattern 361 is formed, can be pressed onto the insulation layers 330, 340 to form additional patterns.

This process can be performed by repeating the process illustrated in FIG. 3A. The carriers 350, 360 and patterns 351, 361 illustrated in FIG. 3F can be formed using the same or similar procedures as those for forming the carriers 310, 320 and patterns 110, 120 illustrated in FIG. 3A.

An operation of forming vias in the insulation layers (S470) will be described with reference to FIG. 3H. The vias 352, 362 can be formed using similar procedures as those for forming the vias 130 described with reference to FIG. 3D.

By repeating the processes illustrated in FIGS. 3F to 3H, a stack of multiple layers of boards can be obtained. In stacking additional boards, not all of the boards have to include buried patterns, and a process of forming patterns over insulation layers can be employed.

As set forth above, a board having buried patterns according to certain embodiments of the invention can have greater rigidity compared to a board having exposed patterns, for the same insulating thickness. Also, a carrier-insulation set having a particular amount of thickness can be utilized to satisfy the thickness requirement in employing an existing roller apparatus intended for thicker boards.

Many embodiments other than those set forth above can be found in the appended claims.

While the spirit of the invention has been described based on particular embodiments, the skilled person will understand that the invention can be implemented in various modified forms without departing from the spirit of the invention. Therefore, the embodiments set forth above are not to be viewed as limiting the invention but as explaining the invention. The scope of the invention is set forth in the appended claims, where variations of the invention are to be seen as encompassed in the invention disclosed herein.

What is claimed is:

1. A board having buried patterns, the board comprising:
an insulation panel;
a first pattern buried in one side of the insulation panel;
a second pattern buried in the other side of the insulation panel with a predetermined insulating thickness between the first pattern and the second pattern; and
a via electrically connecting the first pattern and the second pattern.

2. The board of claim 1, wherein the insulating thickness is greater than or equal to 20 micrometers and lower than or equal to 40 micrometers.

3. The board of claim 1, wherein the first pattern and the second pattern are buried in the insulation panel to depths greater than or equal to 5 micrometers and lower than or equal to 40 micrometers.

4. The board of claim 1, wherein the first pattern and the second pattern are buried in the insulation panel to depths lower than or equal to 10 micrometers, and
the insulating thickness is greater than or equal to 10 micrometers.

5. The board of claim 1, wherein the first pattern and the second pattern are buried in the insulation panel to depths greater than 10 micrometers, and
the insulating thickness is greater than or equal to 20 micrometers.

6. A method of manufacturing a board having buried patterns, the method comprising:
forming a first pattern over one side of a first carrier and forming a second pattern over one side of a second carrier;
forming a carrier-insulation set by pressing the first carrier and the second carrier onto an insulation panel such that the first pattern and the second pattern are buried in the insulation panel;
transporting the carrier-insulation set using rollers; and
removing the first carrier and the second carrier,
wherein a thickness of the carrier-insulation set is greater than or equal to 400 micrometers and lower than or equal to 800 micrometers.
